(19) United States
(12) Patent Application Publication
(10) Pub. No.: US 2022/0154662 A1
(43) Pub. Date: May 19, 2022

(54) METHOD FOR DETERMINING A FUEL CONSUMPTION OF A VEHICLE

(71) Applicant: Volkswagen Aktiengesellschaft, Wolfsburg (DE)

(72) Inventors: Thomas GARBE, Wolfsburg (DE); Steffen HUNKERT, Halberstadt (DE); Yvonne BITTNER, Braunschweig (DE); Michael BIPPES, Braunschweig (DE)

(73) Assignee: Volkswagen Aktiengesellschaft, Wolfsburg (DE)

(21) Appl. No.: 17/525,576

(22) Filed: Nov. 12, 2021

(30) Foreign Application Priority Data
Nov. 13, 2020 (DE) 10 2020 129 992.3

(51) Int. Cl. F02D 41/24

(52) U.S. Cl. CPC F02D 41/2451; F02D 2200/701; F02D 2200/0611; F02D 2200/0625

(57) ABSTRACT

A method and a system for determining a fuel consumption of a vehicle. The method comprises determining a fuel consumption based on a consumption-dependent variable and based on at least one standard value of a fuel material property. The method further comprises determining a fuel material property of the fuel used by the vehicle, calculating a correction value based on the determined fuel material property, and determining a corrected fuel consumption based on the determined fuel consumption and the correction value. In particular, the net CO₂ emission or the greenhouse gas emission can be determined from the renewable share.

This nonprovisional application claims priority under 35 U.S.C. § 119(a) to German Patent Application No. 10 2020 129 992.3, which was filed in Germany on Nov. 13, 2020, and which is herein incorporated by reference.

### BACKGROUND OF THE INVENTION

### Field of the Invention

The present invention relates to a method and a system for determining a fuel consumption of a vehicle.

### Description of the Background Art

European emissions legislation requires automakers to provide a so-called OBFCM, On Board Fuel Consumption Monitoring System, for future vehicles. This system compares the amount of fuel consumed in the vehicle with the number of kilometers driven and thus determines consumption. Narrow tolerances are specified for measurement accuracy.

It is known from the prior art, for example, that the amount of fuel consumed is calculated from the pressure of the fuel rail and the opening times of the injection valve, among other things, although other methods are also known in which consumption-dependent variables are determined in order to determine fuel consumption from them.

Furthermore, material properties of the fuel are required for fuel consumption determination. For this purpose, standard values (conventional values) are used in accordance with the state of the art for fuel density, viscosity, energy content, oxygen content, etc., among other things. However, the use of these standard values can lead to errors, making it difficult to meet the tolerance requirements specified above. Moreover, the consumption determined does not contain any sustainability information.

U.S. Pat. No. 9,995,225 B2 proposes a system in which fuel properties are linked by external components to an on-board computer system to optimize operating modes of an internal combustion engine in terms of efficiency and emissions.

WO 2009/092473 A1 discloses a system with a tank system that transmits information about the fuel to the motor vehicle. Also, on the basis of such information, the combustion in the engine can be controlled by the setting parameters determined for this purpose for injection quantity, injection pressure, injection timings in such a way that optimized combustion results can be achieved.

WO 2013/072939 A1 discloses a determination method for determining fuel consumption by means of a mass ratio of air and fuel and by means of kinematic vehicle parameters.

The prior art does not describe a method with the aim of specifically optimizing the determination accuracy of fuel consumption. Further measures are therefore required to achieve high accuracy.

Even attempts in reducing the measurement tolerances of all components involved in order to keep reserves for the inaccuracies of the fuel material properties may not be sufficient to achieve the required determination tolerances.

In particular, the effort required for accuracy can increase considerably if the legal requirements are tightened. This is aggravated by the fact that it is currently not possible to estimate with certainty whether the solutions incentivized for this purpose will be sufficient for all borderline cases of European fuel qualities.

### SUMMARY OF THE INVENTION

It is therefore an object of the present invention to provide a method and a system for the precise determination of a fuel consumption, which, moreover, can be directly integrated or retrofitted into existing algorithms and monitoring systems.

In an aspect of the invention, it is provided that the method for determining a fuel consumption of a vehicle comprises the following steps. In a first step, a fuel consumption is determined based on at least one fuel consumption-dependent variable and based on at least one standard value of a fuel material property. The method further comprises the step of determining a fuel material property of the fuel used by the vehicle. In a further step, the method comprises calculating a correction value based on the determined fuel material property. In a further step, the method comprises determining a corrected fuel consumption based on the determined fuel consumption and the correction value.

A consumption-dependent variable is a variable that is sensitive to fuel consumption. In other words, such a variable changes dependent on fuel consumption. An example is the opening time of an injection valve or the pressure of the fuel rail, although other variables are used. Thus, fuel consumption can basically be determined from these variables, taking into account the mileage driven. A fuel material property is a direct, preferably chemical, or physical, property of the fuel, i.e., an intrinsic property of the fuel. This may be, for example, a fuel density, viscosity, oxygen content, location of boiling points, energy content, dielectric constant, etc., although the invention is not limited to these. Standard values for fuel material properties here are, in other words, standard values or reference values. Such standard values define values for fuel material properties of an engine type or an associated vehicle type. Such specific or defined standard values can be developed or stored for each vehicle. For example, for a diesel vehicle, such a standard value would be a standard density, standard energy content or other fuel material property standard value defined for diesel, although this is only an example, and such standard values are also assigned or predetermined for other engine types and/or vehicle types. The correction value can preferably be designed as a correction factor, but also as a correction increment. The initially determined fuel consumption can correspond to an output of an OBFCM of the prior art.

The consumption determination method has the advantage that deviations from conventional values or standard values of the fuel material properties are taken into account by the determination method. The method thus takes into account the different fuel material properties of different fuels. The method thus allows for systematic errors in the determination of consumption to be corrected and thus eliminated. As a result, the consumption can be determined more precisely or with higher accuracy. Furthermore, this correction can be easily implemented as a function in addition to the previous OBFCM systems since the basic consumption determination proceeds identically and only then the correction takes place.

The correction value is determined based on a difference between the determined fuel material property and a standard value of the corresponding fuel material property. This allows for the strength of the correction or correction factor to be suitably adjusted to achieve a precise determination of the actual fuel consumption.

The fuel material property can be determined directly by means of a fuel sensor or by means of at least one other vehicle sensor. The fuel sensor can thereby measure a fuel material property directly in the fuel and thus determine direct fuel material properties. Purely by way of example, this may be a dielectric constant, although the invention is not limited to this, and other fuel material properties described above may also be determined directly in the fuel. The other vehicle sensors may be, for example, pressure sensors, a lambda sensor, a temperature sensor, or pump signals, although the invention is not limited thereto. Fuel material properties can then be obtained from these sensors.

Determining the fuel material property can comprise the steps of identifying the fuel type and determining the fuel material property based on the identified fuel type. For example, a fuel type to be identified may be “biodiesel,” E10 gasoline,” or a similar available fuel type. Said fuel material properties may already be known for each fuel type or may be stored in an electronic list corresponding to one another. By means of such a list, i.e., by reading out such a list, a required fuel material property can thus be obtained when the fuel type has been identified.

Preferably, identifying the fuel type can comprise identifying a chemical tracer in the fuel and determining the fuel type based on the identified chemical tracer. In this regard, a chemical tracer may be, in other words, a marker molecule. If a known chemical tracer is uniquely added to a particular fuel type, then the associated fuel type can be determined accordingly via detection of the tracer. A chemical tracer may be, for example, an artificial DNA, although the invention is not limited thereto.

Calculating a correction value can comprise identifying a location of the vehicle and/or of a datum and determining the correction value based on the location of the vehicle and/or based on the datum. Conventional or standard values, for example with respect to the density of the fuel or other fuel material properties, may have a different value at different locations. Purely as an example, a diesel has a lower density in Sweden than in Germany, for example, due to different standards. The location determination thus makes it possible to determine a suitable correction value which takes into account the differences in the standards. The datum, for example as an indicator of temperature, can also be used to adjust or readjust the correction value.

The determination of the corrected fuel consumption by means of the correction value can be performed continuously. This means that a corrected value can be output at all times. This allows for permanent monitoring, e.g., for the vehicle driver, so that the driver can adjust their driving behavior having permanent knowledge of the fuel consumption.

The determination of the corrected fuel consumption can take place at regular time intervals or at specific events. In this case, the determined correction values can be stored according to a time sequence. Then, for example, an averaged correction value, e.g., an arithmetic mean, can be offset against the determined fuel consumption and read out at regular time intervals or at specific events. Such a corrected fuel consumption can then be displayed accordingly when read out.

The method can comprise determining a share of renewable fuels in the fuel consumed and/or a greenhouse gas intensity of the fuel used based on the corrected fuel consumption and the determined fuel material property. Thus, in deviation from a pure consumption determination, a kind of effective consumption can additionally be determined. In other words, a variable can be determined which, in combination with the consumption, represents an indicator for an effective environmental impact and the sustainability of the fuel used and its consumption.

In particular, the net CO₂ emission (i.e., greenhouse gas emission) can be determined from the renewable share.

Also, a system for determining a fuel consumption of a vehicle, adapted to perform the method according to any one of the above examples is provided. The system can be a control unit integrated in the vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a method and a system for determining a fuel consumption of a vehicle according to an embodiment of the invention,

FIG. 2 is a determination of a fuel material property according to a first embodiment of the invention,

FIG. 3 is a determination of a fuel material property according to a second embodiment of the invention, and

FIG. 4 is a determination of the correction factor according to an embodiment of the invention.

### DETAILED DESCRIPTION

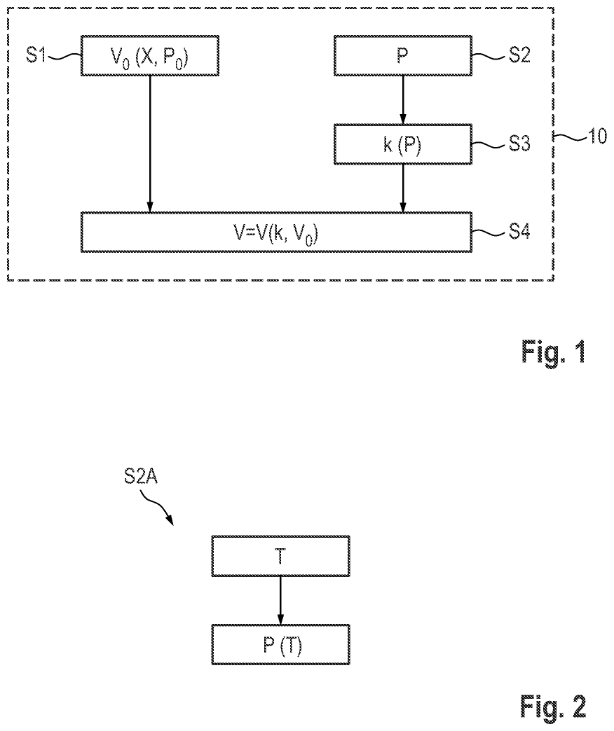

FIG. 1 shows a method according to the invention for determining a fuel consumption according to one embodiment of the invention.

In a first step S1, the method comprises determining a fuel consumption V₀ based on at least one consumption-dependent variable X and based on at least one standard value of a fuel material property P₀. This dependence is represented in the FIG. by V₀(X, P₀). A consumption-dependent variable X is a variable which changes as a function of the amount of fuel consumed. From such a variable, fuel consumption can be determined at least indirectly. Furthermore, the mileage driven can be added. For example, such a variable X can be a pressure of the fuel rail and/or an opening time of the injection valve, but other variables can also be used which are dependent in such a way on the amount of fuel consumed.

The standard value or conventional value of the fuel material property P₀, on the other hand, is a property, preferably a physical and/or chemical property, of the fuel itself. This is thus not dependent on consumption. Such a fuel material property P₀ may be, for example, a density, a viscosity, an energy content, a boiling point location, an oxygen content, a dielectric constant, etc., although the invention is not limited to these examples.

In this determination step, the fuel material property P₀ is entered as a standard value, i.e., as a conventional value. This is a specific value which in typical cases or on average describes or characterizes the fuel material property required for determining consumption. In interaction with the consumption-dependent variable X, a fuel consumption V₀(X, P₀), a basic fuel consumption, can thus be determined. This variable corresponds, for example, to the calculation of a conventional OBFCM system. In the present invention, these standard values or conventional values form the reference point for corrections as described further below.

In a second step, a fuel material property P of the fuel used by the vehicle is determined. This fuel material property of the fuel actually used can deviate from the conventional or standard values. As a fuel material property P, the above-mentioned variables of density, viscosity, energy content, location of the boiling point, oxygen content, dielectric constant may again apply, although the invention is not limited thereto.

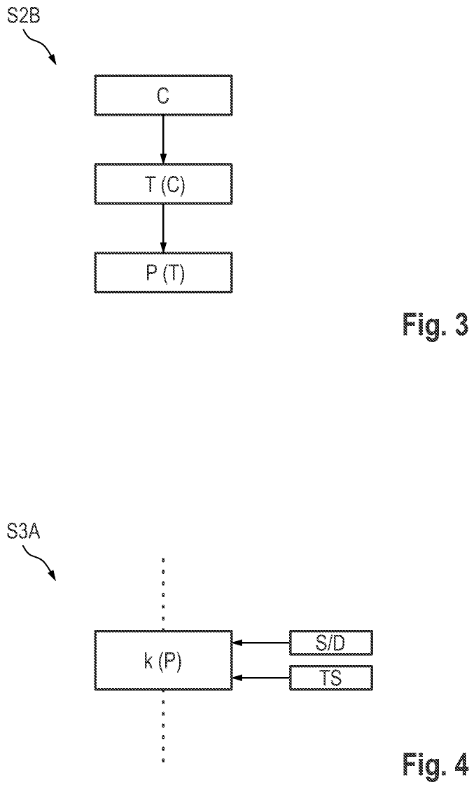

Thus, it may be the case that with respect to a similar and thus comparable fuel material property, P≠P₀, i.e., the determined and actually used fuel material property P differs from the originally used standard value P₀. The determination of the fuel material property P of the fuel used can be carried out in various ways, with preferred embodiments being described in FIGS. 2-3 and below.

In a third step S3, a correction value k is determined on the basis of the determined fuel material property P of the fuel used. The correction value k can be a correction factor, e.g., the value 0.99 or 1.02, or a consumption increment such as −0.01 l/km or 0.02 l/km. The determination of this correction value k is based on the determined fuel material property P.

Preferably, the determination of the correction value k is based on a difference between the determined fuel material property P of the fuel used and a standard value of the corresponding fuel material property P₀. Then, systematically, the deviation from the standard value can be used to determine a suitable correction factor k. This can thus be determined according to a difference distance from the conventional value, so that a greater deviation corresponds to a larger correction.

In a further embodiment, multiple fuel material properties P can also be used to determine the correction value k, for example density and temperature or density and oxygen content or other multiple combinations. For example, multiple fuel material properties P may differ from the corresponding standard values. The correction value k may be based on multiple fuel material properties P. In such a case, the correction factor k may be based on the differences of the respective fuel material properties P from the standard values P₀ corresponding thereto. In such a case, the correction value k can be a sum of individual increments or can also be created by multiplying individual correction value factors, wherein each of the correction values or increments relates to a fuel material property P.

In a fourth step S4, a corrected fuel consumption V is determined on the basis of the determined fuel consumption V₀ and the correction value k, i.e., V=V(k, V₀).

Thus, by taking into account the correction factor k, a fuel material property P deviating from standard values can be taken into account, which can increase the accuracy of the determination of fuel consumption. The invention can be easily retrofitted into existing systems in which only the standard values are used for determination, since the original determination is kept unchanged and then a corrective, i.e., a correction factor k, is determined for it. In particular, systematic errors in the determination of fuel consumption can thus be reduced or eliminated.

Determining the corrected fuel consumption V by means of the correction value k can be done continuously. In such cases, permanent monitoring of fuel consumption is provided by the driver.

Also, the determination of the corrected fuel consumption V can be done at regular time intervals or at specific events. Then, in other words, the correction values k can be accumulated or stored in each case without being output continuously. At the specific times or events, for example, averaged correction values, e.g., in the form of an arithmetic mean, of the stored correction values k at the event or time can then be determined. A fuel consumption determined with such an averaged correction value can then be displayed during readout.

In a particular embodiment of the invention, a fuel material property P of the fuel is determined by means of a fuel sensor. Such a sensor may measure certain fuel material properties of the fuel directly in the fuel itself, for example spectroscopically. For example, the fuel material property P may be a dielectric constant, although the invention is not limited thereto. Other vehicle sensors may also be used to determine the fuel material property P. These may be, for example, pressure sensors, a lambda sensor, a temperature sensor, or pump signals, wherein the invention is not limited thereto. Fuel material properties can then be obtained from these sensors.

Further disclosed is a system 10 for determining fuel consumption, for example, a control unit, which performs the steps described.

FIG. 2 shows another preferred embodiment for determining the fuel material property P. Determining the fuel material property P comprises identifying the fuel type T. Such a fuel type T may be, for example, biodiesel or E10 gasoline or another available fuel type. Each fuel type may have individualized fuel material properties P identifying it. Such an assignment may be pre-stored in an electronic list or memory. Thus, when a fuel type T is identified, a required fuel material property P can be read from the electronic list. Subsequently, the fuel material property P can be based on the identified fuel type T.

FIG. 3 describes a further preferred embodiment. In this embodiment, the fuel type K is identified by means of a chemical tracer C in the fuel. The method comprises the identification of this chemical tracer C in the fuel, for example by means of X-ray fluorescence. Then, based on the identified chemical tracer C, the fuel type K is determined. The various fuels can be pre-prepared in such a way that each fuel is given a characteristic, or unique, chemical tracer. When the tracer is identified, the associated fuel type can thus be inferred. On the basis of the fuel type K, the fuel material property P can in turn be determined in a similar way to FIG. 2.

FIG. 4 shows an embodiment of the invention for determining the correction factor k according to the invention.

In this embodiment, a location S of the vehicle and/or a datum D can be detected, for example by means of a location sensor such as a GPS sensor. Subsequently, the determination of the correction value k may also be based on the location S of the vehicle and/or based on the datum D, i.e., in addition to the value shown in FIG. 1. Different locations S may have different standards for fuel. For example, a diesel fuel may have a lower standard density in Sweden than in, for example, Germany. Thus, a correction value k can be adjusted or post-corrected based on the specific location in order to provide an accurate consumption determination for such a location S as well, despite the different standardization. The correction factor k then also compensates for the difference in standards. The datum, for example as an indicator of a temperature, can also be used to adjust the correction value k. These correction values can be formed as an increment.

A correction value can also be modified by means of a gas station/fuel pump TS or an external central station in order to enable an even more precise determination of the correction value k. This can be done, for example, during the refueling process when the selected fuel is refueled at the gas station/fuel pump TS. This information can be transmitted accordingly to the vehicle by means of a communication interface. A transmission can take place telemetrically. The information from the gas station/fuel pump TS can also be used to determine a fuel material property P according to FIG. 1.

Further, the method may include determining a share of renewable fuels in the consumed fuel based on the corrected fuel consumption V and the determined fuel material property P.

Furthermore, a greenhouse gas intensity, GHG intensity, of the fuel used can also be additionally determined based on the corrected fuel consumption V and the determined fuel material property P. This information can be stored separately and output through separate channels. Furthermore, the values can be combined so that an output signal is combined into a net CO₂/GHG signal, for example. Both a tailpipe-out CO₂ signal (exhaust signal) and a so-called WTW signal (wheel to wheel) are possible, although the invention is not limited to these. Such signals can be used, for example, in validating the tax burden, for example in the vehicle tax.

Advantageously, the output of the fuel consumption can thus be augmented by a second value relating to the sustainability or the CO₂ intensity. Combining the two values in a control unit 10 to an overall signal, which contains the GHG intensity, thus enables transparent monitoring of these effective consumption figures with regard to effective, environmental-friendly input.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining a fuel consumption of a vehicle, the method comprising:
determining a fuel consumption based on a consumption-dependent variable and based on at least one standard value of a fuel material property;
determining a fuel material property of the fuel used by the vehicle;
calculating a correction value based on the determined fuel material property; and
determining a corrected fuel consumption based on the determined fuel consumption and the correction value.

2. The method according to claim 1, wherein the correction value is calculated on the basis of a difference between the determined fuel material property and a standard value of the fuel material property corresponding thereto.

3. The method according to claim 1, wherein the determination of the fuel material property is performed directly by a fuel sensor or is performed by at least one other vehicle sensor.

4. The method according to claim 1, wherein determining the fuel material property comprises:
identifying the fuel type; and
determining the fuel material property based on the identified fuel type.

5. The method according to claim 4, wherein the identification of the fuel type comprises:
identifying a chemical tracer in the fuel; and
determining the fuel type based on the identified chemical tracer.

6. The method according to claim 1, wherein calculating a correction value comprises:
identifying a location of the vehicle and/or a datum; and
calculating the correction value based on the location of the vehicle and/or based on the datum.

7. The method according to claim 1, wherein the determination of the corrected fuel consumption by the correction value is performed continuously.

8. The method according to claim 1, wherein the determination of the corrected fuel consumption is carried out at regular time intervals or at specific events.

9. The method according to claim 1, wherein the method further comprises: determining a share of renewable fuels in the consumed fuel and/or a greenhouse gas intensity of the used fuel based on the corrected fuel consumption and the determined fuel material property.

10. A system for determining a fuel consumption of a vehicle, the system being configured to perform the method according to claim 1.
